(19) United States
(12) Patent Application Publication
(10) Pub. No.: US 2004/0071947 A1
(43) Pub. Date: Apr. 15, 2004

(54) Fiber sheet with heat-treated surface layer

(76) Inventors: Sung-Su Hwang, Suwon-si (KR); Myong-Guk Jeong, Buk-gu (KR); Sung-Young Shim, Ulsan (KR); Sang-Min Jung, Dongnae-gu (KR); Jun Lee, Ulsan (KR)

Correspondence Address: McGuireWoods LLP, Suite 1800, 1750 Tysons Boulevard, Tyson Corner, McLean, VA, 22102-4215, US

(21) Appl. No.: 10/453,725

(22) Filed: Jun. 4, 2003

(30) Foreign Application Priority Data
Oct. 12, 2002 (KR) 10-2002-0062262

(51) Int. Cl. B32B 5/02

(52) U.S. Cl. 428/292.1

(57) ABSTRACT

Disclosed is a fiber sheet having a heat-treated surface layer, comprising a polyester fiber applicable as heat insulating and sound absorbing materials. The fiber sheet is prepared by forming a surface layer at a particular level by continuously heat-treating a surface of the fiber sheet using 1 to 3 sets of hot press rollers at a post-process, where one set of the rollers consists of two rollers vertically arranged. Compared to the conventional products, the fiber sheet of the present invention has improved desurfacing property and bending strength, and good workability and interior property, as well as having improved texture, sound absorbing property and moisture resistance by regulating the size of surface pores.

### TECHNICAL FIELD

The present invention, in general, relates to a fiber sheet prepared by compressing a fiber into a board form, and more particularly, to a fiber sheet having a heat-treated surface layer, prepared by using a polyester fiber applicable as heat insulating and sound absorbing materials as a raw material.

### PRIOR ART

Polyester fiber sheets have been mainly used as bed clothes such as a bed mattress. Owing to their properties of being not harmful to the body in comparison with other heat insulating and sound absorbing materials such as glass wool or rock wool, and being capable of being recycled and thus being environmentally-friendly, the polyester fiber sheets have been recently in the spotlight.

However, when compared to other materials for bed construction, the polyester fiber sheets, which are commercialized as architectural and industrial heat insulating materials or sound absorbing materials, need improvements with respect to workability, sound absorbing property, bending strength and moisture resistance.

### DISCLOSURE OF THE INVENTION

Therefore, it is an object of the present invention to provide a new polyester fiber sheet capable of satisfying the aforementioned requirements.

Leading to the present invention, the intensive and thorough research into a polyester fiber sheet, conducted by the present inventors with an aim of achieving the above object, resulted in the finding that a polyester fiber sheet has improvements in properties required for architectural and industrial heat insulating materials or sound absorbing materials by forming a continuous surface layer of a suitable thickness on a surface of the polyester fiber sheet prepared by heat bonding of a binder fiber and a matrix fiber by a heat sealing process using the thermoplastic property of the polyester fiber, where a hot press roller is employed at downstream of a heat sealing process to form a surface layer on the surface of the fiber sheet at a suitable thickness, thereby allowing the surface layer to be formed continuously with the heat sealing process in a process of preparing a fiber sheet without a separate pressing step.

In accordance with the present invention, there is provided a fiber sheet having a heat-treated surface layer, having a heat-treated surface layer formed on a surface of the fiber sheet by compression using a hot press roller set to a temperature of 150-250° C. and having an average pore size of less than 500 μm, wherein the fiber sheet comprises a polyester binder fiber wholly or partially including a low melting point polyester having a melting point of 80-120° C., and a polyester matrix fiber having a melting point relatively higher than that of the low melting point polyester.

In a preferred embodiment of the present invention, there is provided a method of preparing a fiber sheet having a heat-treated surface layer, comprising preparing a fiber sheet by mixing and carding a polyester binder fiber wholly or partially including a low melting point polyester having a melting point of 80-120° C., and a polyester matrix fiber having a melting point relatively higher than that of the low melting point polyester, layering the resulting webs, and heat-bonding the layered webs at a temperature higher than the melting point of the low melting point polyester and lower than that of the polyester matrix fiber; cooling the heat-bonded fiber sheet; and compressing one or both surfaces of the cooled fiber sheet using a hot press roller set to 150-250° C. to form a heat-treated surface layer having an average pore size of less than 500 μm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a conventional process for preparing a polyester fiber sheet;

FIG. 2 is a diagram showing a process for preparing a polyester fiber sheet having a heat-treated surface layer according to an embodiment of the present invention;

FIG. 3 is a photograph in which a surface of a polyester fiber sheet of Example 1 is magnified; and

FIG. 4 is a photograph in which a surface of a polyester fiber sheet of Comparative Example 1 is magnified.

### BEST MODES FOR CARRYING OUT THE INVENTION

The fiber sheet according to the present invention comprises a polyester binder fiber wholly or partially including a low melting point polyester having a melting point of 80-120° C., and a polyester matrix fiber having a melting point relatively higher than that of the low melting point polyester, and has a heat-treated surface layer formed on a surface thereof by compression using a hot press roller set to 150-250° C., in which the surface layer has an average pore size of less than 500 μm, preferably, 50-500 μm, and more preferably, 100-400 μm.

As a result of analyzing variations in physical properties of fiber sheet according to the average pore size of the heat-treated surface layer formed a surface thereof, when having a surface layer with an average pore size within the above range, the surface heat-treated fiber sheet is 10 found to show improvements in sound absorbing property of about 5-20%, bending strength of about 5-50%, and moisture resistance of about 50-70%.

When the average pore size of the heat-treated surface layer formed on a surface of the fiber sheet exceeds 500 μm, the fiber sheet has poor sound absorbing property, bending strength and moisture resistance. In contrast, if the average pore size of the heat-treated surface layer is very small, the fiber sheet should be treated using a hot press roller set to a higher temperature for a long period of time, and such a treatment for a long time may cause deformation of products. Therefore, the average pore size is preferably more than 50 μm, and more preferably, more than 100 μm.

The polyester binder fiber wholly or partially including a low melting point polyester having a melting point of 80-120° C., preferably, has a monofilament fineness of 2-4 denier, and is preferably contained in the fiber sheet at an amount of 20-80 wt %. The polyester matrix fiber, preferably, has a melting point higher than that of the low melting point polyester and a monofilament fineness of 3-15 denier, and is preferably contained in the fiber sheet at an amount of 20-80 wt %.

The polyester matrix fiber used in the present invention, which functions to improve texture, appearance and surface strength of resulting fiber sheets, and serves as sound absorbing and heat insulating materials, is preferably used in a conjugate fiber form in which components are mixed at a predetermined ratio, and preferably 3-15 denier. As a polyester binder fiber, a binder fiber comprising only a low melting point polyester having a melting point of 80-120° C. may be used. Preferably, a sheath-core or side-by-side polyester conjugate fiber composed of a low melting point polyester having a melting point of 80-120° C. and a high melting point polyester is used. In such a case, of the two polymers, only the low melting point polyester is melted at a heat-sealing process, thus effecting its bonding to the polyester matrix fiber.

In accordance with a preferred embodiment of the present invention, there is provided a method of preparing a fiber sheet having a heat-treated surface layer, in which a binder fiber and a matrix fiber are mixed and carded, webs are formed and layered, and the layered webs are preheated by a preheating means to transport the resulting web-layered product having a uniform arrangement to a melting heat treatment mean. The web-layered product is melted and heat-treated at a temperature higher than a melting point of the binder fiber and lower than a melting point of the matrix fiber, preferably, 100-150° C., by the melting heat treatment means to produce a heat-bonded fiber sheet. Then, the heat-bonded fiber sheet passes a cooling zone where a surface of the fiber sheet is cooled, and undergoes a compression process by a hot press roller. The hot press roller is set to a temperature higher than the temperature at the melt heat treatment, and preferably, 150-250° C. If the fiber sheet having passed the heat-sealing process is directly transported to the hot press roller, the fiber sheet sticks to the roller owing to the residual heat at its surface. For this reason, after being heat-bonded, a surface of the fiber sheet should be cooled via the cooling zone prior to application to the roller.

When the cooled fiber sheet passes the space between two hot press rollers, its one or both surfaces are heat-treated. One set of the rollers consists of two rollers that are vertically arranged. When the cooled fiber sheet passes one to three sets of the rollers, the binder fiber of the fiber sheet, which is facing the rollers, is melted and bonded, resulting in formation of a surface layer having density and pore size different from the interior layer of the fiber sheet. After heat-sealing, the resulting fiber sheet undergoes a cooling process to produce a fiber sheet having an uniform thickness. In case that one surface of the fiber sheet is intended to be heat-treated, one roller of each set is adjusted to a temperature lower than a setting temperature suitable for heat-sealing. In case that both surfaces of the fiber sheet is intended to be heat-treated, two rollers of each set are adjusted to a setting temperature suitable for heat-sealing.

On the other hand, when the polyester binder fiber comprises more components, temperature or pressure of the hot press rollers is increased, or more rollers are used, the surface layer has increased thickness and density, as well as having pores of much smaller size. Therefore, such properties of the surface layer may be controlled according to its use. In particular, the pore size at the surface layer of the fiber sheet may be controlled to within a limited range to maximize the effects of interest in the present invention.

The present invention will be explained in more detail with reference to the following examples. However, the following examples are provided only to illustrate the present invention, and the present invention is not limited to them.

### EXAMPLE 1

After opening, mixing and carding 60 wt % of a sheath-core structured polyester conjugate fiber (melting point of a sheath part: 120° C.) having a monofilament fineness of 4 denier, which is used as a binder fiber, and 40 wt % of a polyethylene terephtalate fiber (melting point: 260° C.) having a monofilament fineness of 15 denier, which is used as a matrix fiber, the resulting webs were layered. The layered webs were preheated, and melted and heat-treated at 130° C., leading to heat-bonding of the binder fiber and the matrix fiber. After being cooled, the resulting fiber sheet was passed through the space between hot press rollers set to a temperature of 150° C. and a contact pressure of more than 38.5 kg/cm (10 Ton/roller), resulting in formation of heat-treated surface layers having a thickness of 25 mm and a density of 100 kg/m³ on its both surfaces. The final fiber sheet was cut at a predetermined size to obtain a sample for analyzing physical properties of the fiber sheet (see FIG. 2). Magnified image of a surface of the sample was captured by a camera (see FIG. 3), and the sample was evaluated for an average pore size, sound absorbing property and bending strength according to the following methods. The results are given in Table 2, below.

Average pore size: After obtaining a test specimen of 1 cm² from the fiber sheet, an average pore size was measured on a surface of the test specimen.

Sound absorbing property: Sound absorbing property of the test specimen was measured by a transfer function method according to KS F 2814-2 (standard method for determining sound absorption coefficients and impedance using an impedance tube), and represented as NRC (noise reduction coefficient) calculated using sound absorption coefficients (SAC) obtained from the test in a reverberation room, where the NRC is a four frequency average of the SAC at selected frequencies.

Bending strength: Bending strength was measured according to KS M 3808 (standard method for testing foam polystyrene thermal insulation materials).

### EXAMPLES 2 to 4

Fiber sheets were prepared according to the same method as in Example 1 except for modifying the heat-treatment condition by the hot press rollers, as shown in Table 1, below.

### COMPARATIVE EXAMPLE 1

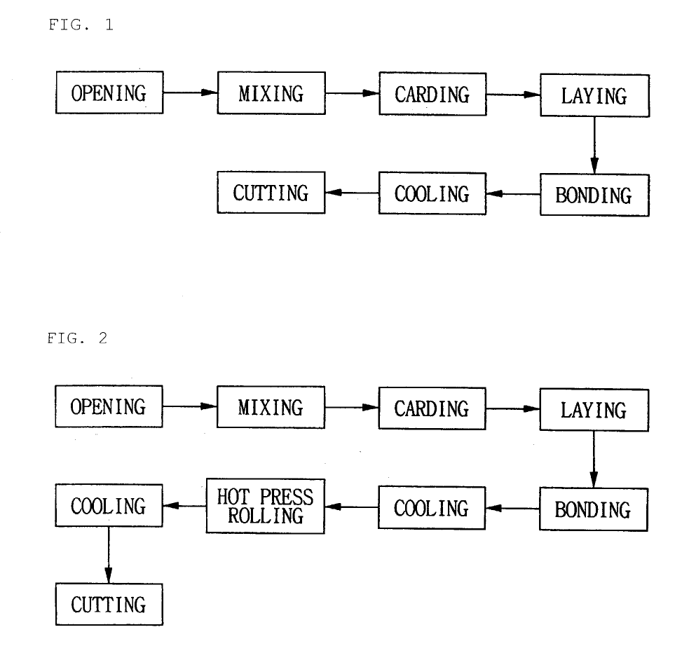

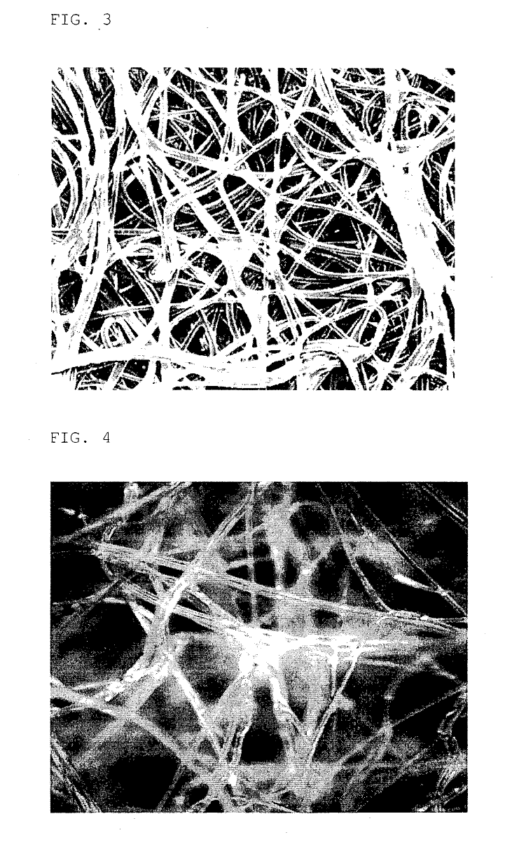

After opening, mixing and carding 60 wt % of a sheath-core structured polyester conjugate fiber (melting point of a sheath part: 120° C.) having a monofilament fineness of 4 denier, which is used as a binder fiber, and 40 wt % of a polyethylene terephtalate fiber (melting point: 260° C.) having a monofilament fineness of 15 denier, which is used as a matrix fiber, the resulting webs were layered. The layered webs were preheated, and melted and heat-treated at 130° C., leading to heat-bonding of the binder fiber and the matrix fiber, followed by cooling. The resulting fiber sheet was cut at a predetermined size to obtain a sample for analyzing physical properties of the fiber sheet (see FIG. 1). A magnified image of a surface of the sample was captured by a camera (see FIG. 4), and the sample was evaluated for an average pore size, sound absorbing property and bending strength according to the same methods in Example 1. The results are given in Table 2, below.

### EXAMPLE 5

After opening, mixing and carding 30 wt % of a sheath-core structured polyester conjugate fiber (melting point of a sheath part: 120° C.) having a monofilament fineness of 4 denier, which is used as a binder fiber, and 70 wt % of a polyethylene terephtalate fiber (melting point: 260° C.) having a monofilament fineness of 3 denier, which is used as a matrix fiber, the resulting webs were layered. The layered webs were preheated, and melted and heat-treated at 130° C., leading to heat-bonding of the binder fiber and the matrix fiber. After being cooled, the final fiber sheet was passed through the space between hot press rollers set to a temperature of 150° C. and a contact pressure of more than 38.5 kg/cm (10 Ton/roller), resulting in formation of heat-treated surface layers having a thickness of 50 mm and a density of 32 kg/m³ on its both surfaces. The resulting fiber sheet was cut at a predetermined size to obtain a sample for analyzing physical properties of the fiber sheet. The test sample was evaluated for an average pore size, sound absorbing property and bending strength according to the same methods as in Example 1, and moisture transmission coefficients were measured by the 5.2 cup method according to KS F 2607 (standard method for measuring moisture permeability of architectural materials). The results are given in Table 2, below.

### EXAMPLE 6

A fiber sheet was prepared according to the same method as in Example 5 except for modifying the heat-treatment condition by the hot press rollers, as shown in Table 1, below.

### COMPAPATIVE EXAMPLE 2

After opening, mixing and carding 30 wt % of a sheath-core structured polyester conjugate fiber (melting point of a sheath part: 120° C.) having a monofilament fineness of 4 denier, which is used as a binder fiber, and 70 wt % of a polyethylene terephtalate fiber (melting point: 260° C.) having a monofilament fineness of 3 denier, which is used as a matrix fiber, the resulting webs were layered. The layered webs were preheated, and melted and heat-treated at 130° C., leading to heat-bonding of the binder fiber and the matrix fiber, followed by cooling. The resulting fiber sheet was cut at a predetermined size to obtain a sample for analyzing physical properties of the fiber sheet. The test sample was evaluated for an average pore size, sound absorbing property, bending strength and moisture transmission coefficients according to the same methods as in Example 5. The results are given in Table 2, below.

TABLE 1

| | |
|---|---|
| Components of fiber sheet | Hot press roller |

| | | | | | |
|---|---|---|---|---|---|
| Thickness | Density | Binder | Matrix | Temp. | Heat-treated |
| (mm) | (kg/m³) | fiber | fiber | (° C.) | surface |

| | | | | | | |
|---|---|---|---|---|---|---|
| E. 1 | 25 | 100 | 4 de, 60 wt % | 15 de, 40 wt % | 150 | Both surfaces |
| E. 2 | 25 | 100 | 4 de, 60 wt % | 15 de, 40 wt % | 200 | Both surfaces |
| E. 3 | 25 | 100 | 4 de, 60 wt % | 15 de, 40 wt % | 200 | One surface |
| E. 4 | 25 | 100 | 4 de, 60 wt % | 15 de, 40 wt % | 250 | Both surfaces |
| C. E. 1 | 25 | 100 | 4 de, 60 wt % | 15 de, 40 wt % | — | — |
| E. 5 | 50 | 32 | 4 de, 30 wt % | 15 de, 70 wt % | 200 | One surface |
| E. 6 | 50 | 32 | 4 de, 30 wt % | 15 de, 70 wt % | 200 | Both surfaces |
| C. E. 2 | 50 | 32 | 4 de, 30 wt % | 15 de, 70 wt % | — | — |

TABLE 2

| | Surface | Physical properties | | |
|---|---|---|---|---|
| | pore | Sound absorbing | Bending strength | (g/m²h |
| | size (μm) | property (NRC) | (N/cm²) | mm Hg) |
| E.1 | 300 | 0.45 | 11.3 | — |
| B.2 | 150 | 0.46 | 14.1 | — |
| E.3 | 150 | 0.46 | 12.0 | — |
| E.4 | 80 | 0.48 | 17.9 | — |
| C.E.1 | 750 | 0.42 | 11.3 | — |
| E.5 | 400 | 0.75 | 0.294 | 0.580 |
| E.6 | 400 | 0.75 | 0.302 | 0.360 |
| C.E.2 | 1300 | 0.70 | 0.289 | 0.340 |

### INDUSTRIAL APPLICABILITY

As apparent from data shown in the above Table 2, when compared to the conventional fiber sheet, the fiber sheet having a heat-treated surface layer according to the present invention has improvements in texture, desurfacing property, sound absorbing property, bending strength and moisture resistance, which are required in heat insulating and sound absorbing materials, as well as being advantageous in terms of being continuously producible by improving the conventional manufacturing process.

1. A fiber sheet having a heat-treated surface layer, formed on a surface of the fiber sheet by compression using a hot press roller set to a temperature of 150-250° C. and having an average pore size of less than 500 μm, wherein the fiber sheet comprises a polyester binder fiber wholly or partially including a low melting point polyester having a melting point of 80-120° C., and a polyester matrix fiber having a melting point relatively higher than that of the low melting point polyester.

2. The fiber sheet as set forth in claim 1, wherein the average pore size of the heat-treated surface layer is from 50 to 500 μm.

3. The fiber sheet as set forth in claim 1, wherein the average pore size of the heat-treated surface layer is from 100 to 400 μm.

4. A method of preparing a fiber sheet having a heat-treated surface layer, comprising:
preparing a fiber sheet by mixing and carding a polyester binder fiber wholly or partially including a low melting point polyester having a melting point of 80-120° C., and a polyester matrix fiber having a melting point relatively higher than that of the low melting point polyester, layering the resulting webs, and heat-bonding the layered webs at a temperature higher than the melting point of the low melting point polyester and lower than that of the polyester matrix fiber;
cooling the heat-bonded fiber sheet; and
compressing one or both surfaces of the cooled fiber sheet using a hot press roller set to 150-250° C. to form a heat-treated surface layer having an average pore size of less than 500 μm.
